(19) United States
(12) Patent Application Publication
(10) Pub. No.: US 2019/0012622 A1
(43) Pub. Date: Jan. 10, 2019

(54) COMPUTER-READABLE RECORDING MEDIUM FOR VISUALIZATION OF MANUFACTURING-PROCESS, METHOD OF VISUALIZING MANUFACTURING PROCESS, AND MANUFACTURING-PROCESS VISUALIZING SYSTEM

(71) Applicant: FUJITSU LIMITED, Kawasaki-shi (JP)

(72) Inventors: Takehiko Nishimura, Kawasaki (JP); Hiroyuki Matsushita, Kawasaki (JP); Yuki Sato, Yokohama (JP); Kazuki Takahashi, Wako (JP); Tomohiko Maeda, Setagaya (JP)

(73) Assignee: FUJITSU LIMITED, Kawasaki-shi (JP)

(21) Appl. No.: 16/115,906

(22) Filed: Aug. 29, 2018

Related U.S. Application Data
(63) Continuation of application No. PCT/JP2016/057477, filed on Mar. 9, 2016.

(51) Int. Cl. G06Q 10/06; G06Q 50/04

(52) U.S. Cl. CPC G06Q 10/0633; G06Q 50/04

(57) ABSTRACT

A non-transitory computer-readable recording medium stores therein a manufacturing-process visualizing program that causes a computer to execute a process including acquiring manufacture data including identification information for a manufacture product, identification information for a manufacturing process, and time information indicating a time captured at a time when the manufacture product has undergone the manufacturing process; determining all manufacturing processes which a specific manufacture product has undergone, and determining an order of each of manufacturing processes based on time information associated with each of the manufacturing processes; and arranging, in the determined order, identification information or symbol information, and generating a graph in which a time when the specific manufacture product undergoes each of the manufacturing processes is, along a predetermined time axis direction, associated with the identification information for each of the manufacturing processes or the symbol information on each of the manufacturing processes, which has been arranged.

### CROSS-REFERENCE TO RELATED APPLICATION

This application is a continuation of International Application No. PCT/JP2016/057477, filed on Mar. 9, 2016, the entire contents of which are incorporated herein by reference.

### FIELD

The embodiment discussed herein is related to a manufacturing-process visualizing program, a method of visualizing a manufacturing process, and a manufacturing-process visualizing system.

### BACKGROUND

Data involved in activities of enterprises is accumulated and utilized. For example, data such as an operation log of a manufacturing device in a manufacturing line for a product is accumulated and utilized for improvements in a production process. In addition, it has been proposed to estimate, for an improvement in a production process, a fundamental cause of an abnormality occurred in a manufacturing line among various causes based on a causal relation.

Japanese Laid-open Patent Publication No. 2009-116842

Unfortunately, for example, if result data on a manufacturing line is graphed, definitions of the order or characteristics of production processes are needed. Furthermore, in a manufacturing line for manufacturing various types of products, products may undergo production processes that are different according to product types. Consequently, heavy burdens are put on workers on production sites if the workers define the order or characteristics of the production processes based on the different production processes.

### SUMMARY

According to an aspect of an embodiment, a non-transitory computer-readable recording medium stores therein a manufacturing-process visualizing program that causes a computer to execute a process for visualizing a manufacturing process in a manufacturing line based on manufacture data acquired in processing of manufacturing a manufacture product in the manufacturing line. The process includes: acquiring manufacture data including identification information for a manufacture product, identification information for a manufacturing process which the manufacture product has undergone, and time information indicating a time captured at a time when the manufacture product has undergone the manufacturing process; determining all manufacturing processes which a specific manufacture product has undergone, based on the acquired manufacture data, and determining an order of each of manufacturing processes based on time information associated with each of the manufacturing processes involved in all the determined manufacturing processes; and arranging, in the determined order, identification information for each of the manufacturing processes or symbol information on each of the manufacturing processes, and generating a graph in which a time when the specific manufacture product undergoes each of the manufacturing processes is, along a predetermined time axis direction, associated with the identification information for each of the manufacturing processes or the symbol information on each of the manufacturing processes, which has been arranged.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating one example of configurations of a manufacturing-process visualizing system in an embodiment;

FIG. 2 illustrates one example of manufacture data storage units;

FIG. 3 illustrates one example of process master-storage units;

FIG. 4 illustrates one example of route changes in a manufacturing line;

FIG. 5 illustrates one example of generation of a graph from event-based manufacture data;

FIG. 6 illustrates one example of graphs;

FIG. 7 illustrates another example of graphs;

FIG. 8 illustrates another example of graphs;

FIG. 9 illustrates another example of graphs;

FIG. 10 illustrates another example of graphs;

FIG. 11 illustrates another example of graphs;

FIG. 12 is a flowchart illustrating one example of visualization processing in the embodiment; and

FIG. 13 illustrates one example computers that execute a manufacturing-process visualizing program.

### DESCRIPTION OF EMBODIMENT

Preferred embodiments of the present invention will be explained with reference to accompanying drawings. Note that techniques to be disclosed are not limited to the embodiment. Furthermore, the following embodiment may be appropriately combined in a consistent range.

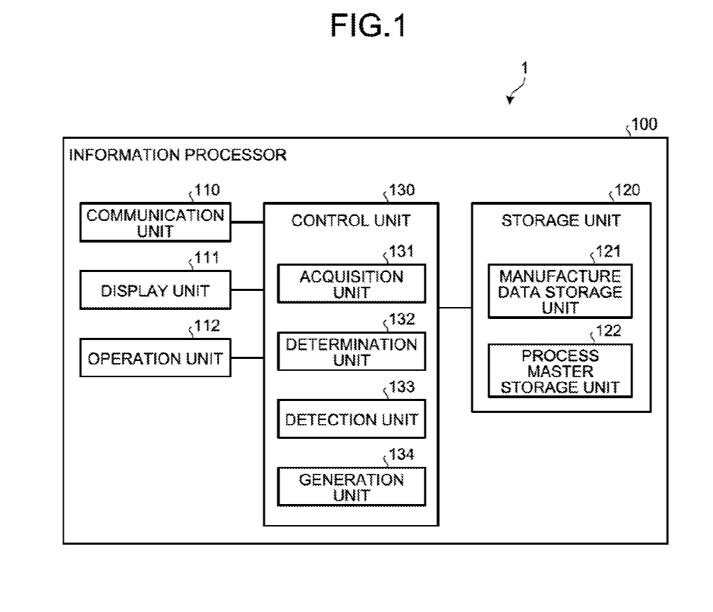

FIG. 1 is a block diagram illustrating one example of configurations of a manufacturing-process visualizing system in an embodiment. A manufacturing-process visualizing system 1 illustrated in FIG. 1 includes an information processor 100. In addition to the information processor 100, the manufacturing-process visualizing system 1 may include, for example, a controller for each manufacturing process, a controller for a machine tool, and various testers for temperature tests or any other test. The information processor 100 can acquire result data on a manufacturing line, in other words, manufacture data from various devices. The manufacturing-process visualizing system 1 may also include a terminal for an administrator. The information processor 100 and the various devices are connected so as to communicate with each other via a network (not illustrated). Note that, in the following description, a case in which various pieces of information including time information in a manufacturing line for a manufacture product (hereinafter, also referred to as a product) are acquired as manufacture data will be described in one example.

The information processor 100 in the manufacturing-process visualizing system 1 illustrated in FIG. 1 visualizes a manufacturing process in a manufacturing line based on manufacture data acquired in a process of manufacturing a manufacture product in a manufacturing line. That is, the information processor 100 acquires manufacture data including identification information for a manufacture product, identification information for a manufacturing process which the manufacture product has undergone, and time information indicating a time captured at the time when the manufacture product has undergone the manufacturing process. The information processor 100 determines all manufacturing processes which a specific manufacture product has undergone, based on the acquired manufacture data, and determines the order of each manufacturing process based on time information associated with each manufacturing process involved in all the determined manufacturing processes. The information processor 100 arranges, in the determined order, identification information for each manufacturing process or symbol information on each manufacturing process. The information processor 100 generates a graph in which the time when the specific manufacture product undergoes each manufacturing process is, along a predetermined time axis direction, associated with the identification information for each manufacturing process or the symbol information on each manufacturing process, which has been arranged. This enables the information processor 100 to easily graph result data.

As illustrated in FIG. 1, the information processor 100 includes a communication unit 110, a display unit 111, an operation unit 112, a storage unit 120, and a control unit 130. Note that, in addition to the functional units illustrated in FIG. 1, the information processor 100 may include various functional units included in known computers, for example, functional units such as various input devices and voice output devices. In one example, the information processor 100 can employ a stationary personal computer. In addition to the above stationary personal computer, the information processor 100 can employ a portable personal computer as the information processor 100. Furthermore, the information processor 100 can employ, for example, a tablet terminal as a portable terminal in addition to the above portable personal computer.

The communication unit 110 is implemented by, for example, a network interface card (NIC). The communication unit 110 is a communication interface that is connected to various devices via a network (not illustrated) by wire or wirelessly, and that communicates information between various devices. The communication unit 110 receives manufacture data from the various devices. The communication unit 110 outputs the received manufacture data to the control unit 130.

The display unit 111 is a display device for displaying various pieces of information. The display unit 111 is implemented by, for example, a liquid crystal display as a display device. The display unit 111 displays various screens such as display screens input from the control unit 130.

The operation unit 112 is an input device that receives various operations from an administrator of the manufacturing-process visualizing system 1. The operation unit 112 is implemented by, for example, a keyboard or a mouse as an input device. The operation unit 112 outputs, to the control unit 130 as operation information, the operation that is input from an administrator. Note that the operation unit 112 may be implemented by, for example, a touch panel as an input device, and the display device of the display unit 111 and the input device of the operation unit 112 may be integrally provided.

The storage unit 120 is implemented by, for example, a semiconductor memory element such as a random access memory (RAM) and a Flash Memory, or a storage such as a hard disk and an optical disk. The storage unit 120 includes a manufacture data storage unit 121 and a process master storage unit 122. Furthermore, the storage unit 120 stores information used in processing in the control unit 130.

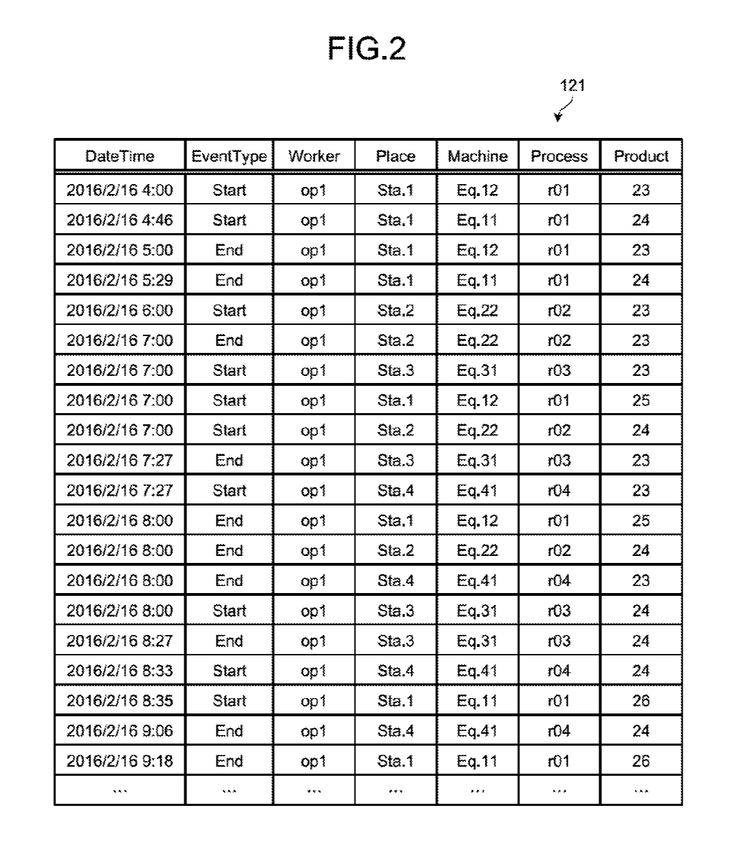

The manufacture data storage unit 121 stores event-based manufacture data obtained by associating various pieces of information on a manufacture product with time information. FIG. 2 illustrates one example of the manufacture data storage unit. As illustrated in FIG. 2, the manufacture data storage unit 121 includes items such as “DateTime”, “EventType”, “Worker”, “Place”, “Machine”, “Process”, and “Product”. For example, the manufacture data storage unit 121 stores each event as one record.

“DateTime” is information on the date and time when an event has occurred. “EventType” is information on the type of the event. “Worker” is identification information for identifying a worker in charge of a manufacturing process. “Place” is identification information for identifying a place provided with equipment of the manufacturing line at which the event has occurred. “Machine” is identification information for identifying equipment of the manufacturing line at which the event has occurred. “Process” is identification information for identifying the manufacturing process to which the event has occurred. “Product” is identification information for identifying a manufacture product, in other words, a product, to which the event has occurred. That is, the manufacture data storage unit 121 stores manufacture data including identification information for a manufacture product, identification information for a manufacturing process which the manufacture product has undergone, and time information indicating a time captured at the time when the manufacture product has undergone the manufacturing process.

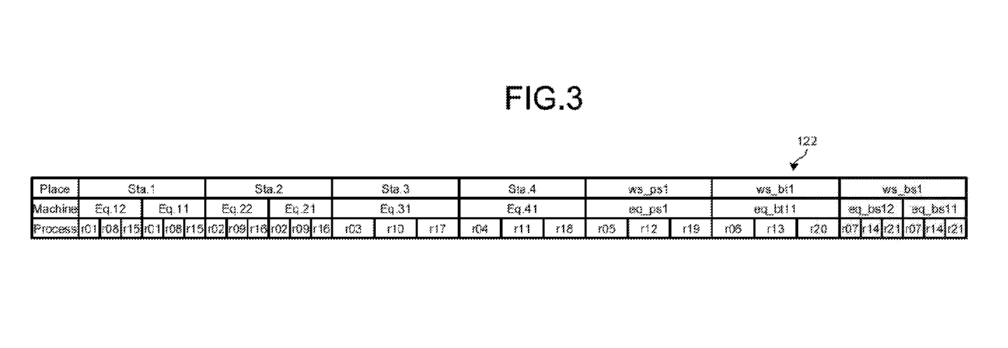

Referring back to FIG. 1, the process master storage unit 122 stores a process master that defines, for example, process names and the orders of manufacturing processes. FIG. 3 illustrates one example of the process master storage unit. As illustrated in FIG. 3, the process master storage unit 122 includes items such as “Place”, “Machine”, and “Process”. The process master storage unit 122 also stores identification information for a place, identification information for equipment, and identification information for a manufacturing process, which are associated with each item.

“Place” is identification information for identifying a place provided with equipment of the manufacturing line at which the event has occurred. “Machine” is identification information for identifying equipment of the manufacturing line at which the event has occurred. “Process” is identification information for identifying the manufacturing process to which the event has occurred. The process master storage unit 122 also stores a priority order of levels in a hierarchy established based on an analysis result of a relation between, for example, a manufacturing process, a place and equipment. The process master storage unit 122 also stores identification information for a place, identification information for equipment, and identification information for a manufacturing process with these pieces of information arranged, for example, in the ascending order of the identification information for the manufacturing process. Note that the process master storage unit 122 may store symbol information for a manufacturing process instead of the identification information for a manufacturing process.

Referring back to FIG. 1, the control unit 130 is implemented by executing a program stored in a storage therein. For example, a central processing unit (CPU) or micro processing unit (MPU) executes the program by using a RAM as a work area. The control unit 130 may also be implemented by integrated circuits such as an application specific integrated circuit (ASIC) and a field programmable gate array (FPGA). The control unit 130 includes an acquisition unit 131, a determination unit 132, a detection unit 133, and a generation unit 134. The control unit 130 implements or executes the following functions or actions of information processing. Note that, the internal configuration of the control unit 130 is not limited to that in FIG. 1. The control unit 130 may have a different configuration as long as information is processed as described later through the configuration. Note that, in the following description, a line segment associated with each manufacture product is also referred to as a trace graph, and an entire graph including a time axis for each manufacturing process and a trace graph associated with each manufacture product is also referred to as a time line graph.

The acquisition unit 131 receives and acquires manufacture data from various devices (not illustrated) through the communication unit 110. The acquired manufacture data includes identification information for a manufacture product, identification information for a manufacturing process which the manufacture product has undergone, and time information indicating a time captured at the time when the manufacture product has undergone the manufacturing process. The acquisition unit 131 stores the acquired manufacture data in the manufacture data storage unit 121. More specifically, the acquisition unit 131 accumulates and stores the manufacture data received from the various devices (not illustrated) in the manufacture data storage unit 121 with each event defined as one record.

The determination unit 132 reads manufacture data from the manufacture data storage unit 121 when the determination unit 132, for example, receives an instruction to display a graph from an administrator of the manufacturing-process visualizing system 1. The determination unit 132 determines all manufacturing processes which a specific manufacture product has undergone, based on the read manufacture data. The determination unit 132 also determines the order of each manufacturing process based on time information associated with each manufacturing process involved in all the determined manufacturing processes. More specifically, with respect to a manufacturing line through which a plurality of types of manufacture products passes in a mixed manner, or a manufacturing line having plural pieces of equipment that has the same function, the determination unit 132 determines a route of the manufacturing line through which the manufacture product has passed for each manufacture product included in the manufacture data. The determination unit 132 outputs the order of each of the determined manufacturing processes to the generation unit 134. The determination unit 132 also outputs a characteristic detection instruction to the detection unit 133.

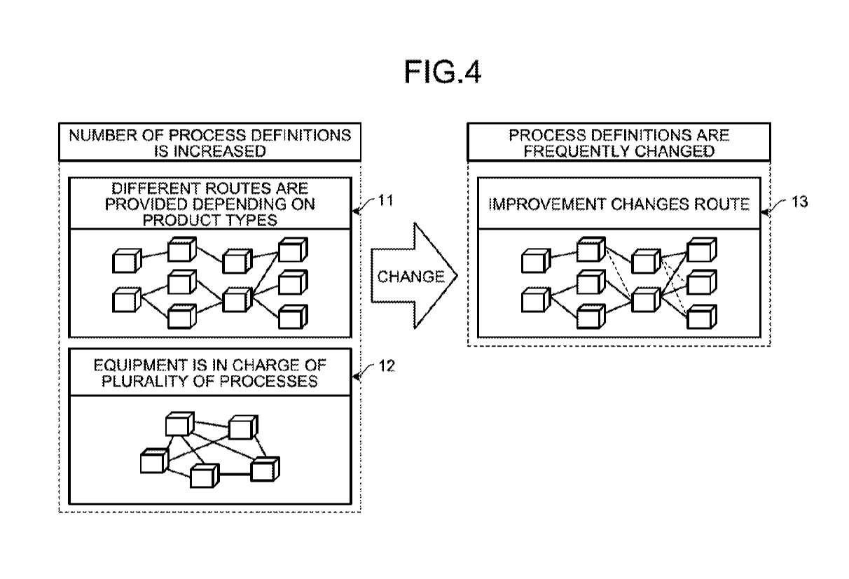

A route change of a manufacturing line will now be described with reference to FIG. 4. FIG. 4 illustrates one example of route changes of a manufacturing line. As illustrated in FIG. 4, in a manufacturing line, the number of process definitions is increased in a case 11 and case 12. In the case 11, different routes are provided depending on product types. In a case 12, equipment is in charge of a plurality of processes (manufacturing processes). Furthermore, in the case 11, an improvement in a manufacturing line may change a route as indicated by a dotted line in a case 13. More specifically, continual improvements lead to high frequency of changes of the process definitions. In such circumstances, where a route is divided and where routes intersect are more important than the order of manufacturing processes. More specifically, in mass production in which plural types of products pass through a manufacturing line in a mixed manner, production through an unexpected flow for a specific type leads to a deterioration in quality. Consequently, in visualization of a manufacturing process, visualization of bottlenecked equipment or idle equipment by focusing not only on a flow of a manufacture product but on equipment or a place is needed.

Referring back to FIG. 1, the detection unit 133 reads manufacture data from the manufacture data storage unit 121 when a characteristic detection instruction is input from the determination unit 132. The detection unit 133 defects characteristics of each manufacturing process based on the read manufacture data. For example, characteristics of a manufacturing process include a single process, a parallel process, and a batch process. In the single process, manufacture products are independently manufactured and processed one by one. In the parallel process, a plurality of manufacture products is manufactured and processed in parallel. In the batch process, manufacture products are manufactured and processed by batch at every specific timing. The detection unit 133 outputs process evaluation information including the detected characteristics of each manufacturing process to the generation unit 134.

The order of each manufacturing process is input from the determination unit 132 to the generation unit 134. Referring to the manufacture data storage unit 121, the generation unit 134 analyzes a relation between pieces of information. The information includes the identification information for each manufacturing process, or symbol information on each manufacturing process, which is to be arranged, and information on one or more of a place and equipment that is associated with each manufacturing process. Based on the analysis result, the generation unit 134 determines a priority order in a hierarchy of each piece of the information to be arranged in a graph.

In an analysis of a relation between pieces of information, the generation unit 134 determines, for example, a parent-child relation in round-robin fashion, and extracts information as a parent in the order from information most frequently determined to be a parent. Information that frequently appears thereby can be analyzed as a parent. The generation unit 134 determines a priority order such that information that appears more frequently has higher priority. In other words, the generation unit 134 classifies a piece of information with higher priority as a large item, and a piece of information with next higher priority as a medium item.

The generation unit 134 hierarchizes each piece of the information based on the determined priority order. Note that each level corresponding to each piece of the hierarchized information may be rearranged through operation by an administrator. The generation unit 134 arranges each piece of the hierarchized information in a graph in the order of each manufacturing process input from the determination unit 132. More specifically, the generation unit 134 determines an arrangement of item columns in the graph. Note that, in an arrangement of item columns, the order of the arrangement may be changed through operation by an administrator.

In addition, when process evaluation information is input from the detection unit 133, the generation unit 134 places the input process evaluation information in a graph in association with identification information for each manufacturing process or symbol information for each manufacturing process. That is, the generation unit 134 associates the detected characteristics of the manufacturing process with the identification information for each manufacturing process or the symbol information for each manufacturing process in the graph.

Then, the generation unit 134 generates a trace graph associated with a manufacture product. The generation unit 134 generates the trace graph by associating, along a predetermined time axis direction, a time when each manufacture product undergoes each manufacturing process with the arranged item column. In other words, the generation unit 134 generates a graph in which the time when a specific manufacture product undergoes each manufacturing process is, along a predetermined time axis direction, associated with the identification information for each manufacturing process or the symbol information on each manufacturing process, which has bees arranged. That is, the generation unit 134 generates a graph based on the order and the priority order of the manufacturing processes.

The generation unit 134 displays the generated graph on the display unit 111. Note that, for example, when an administrator places a mouse cursor on (mouse over) a trace graph associated with a manufacture product, the generation unit 134 may cause the trace graph associated with the manufacture product to be highlighted. The generation unit 134 also stores the arrangement of the item columns used in the displayed graph as a process master in the process master storage unit 122.

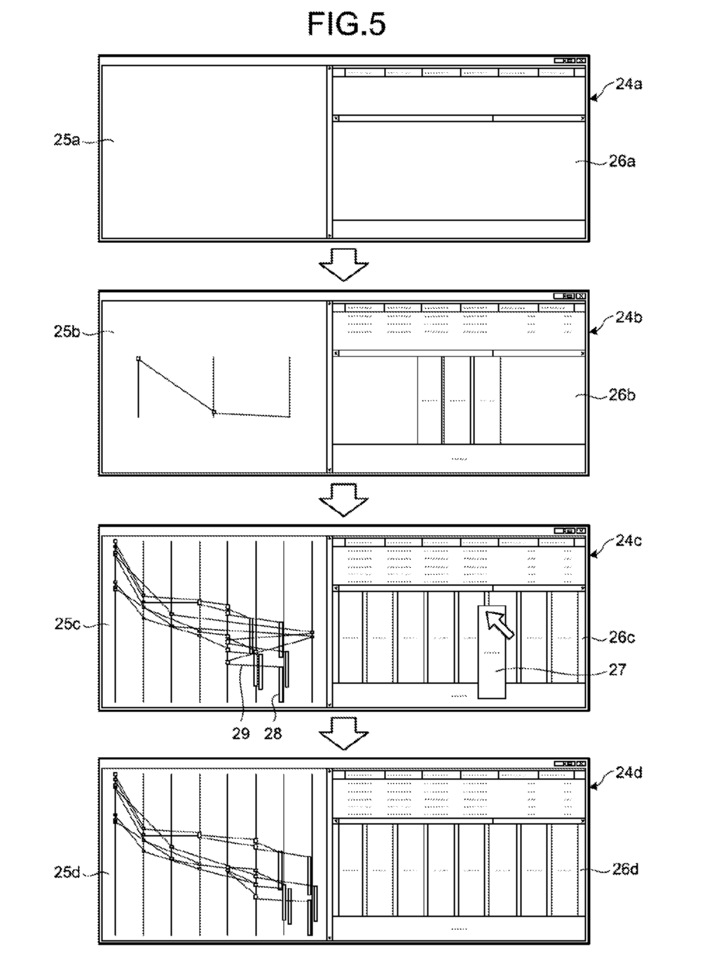

Generation of a graph from manufacture data will now be described with reference to FIG. 5. FIG. 5 illustrates one example of generation of a graph from event-based manufacture data. In the example in FIG. 5, a trace graph corresponding to a read manufacture data is illustrated in the order of graphs 24a, 24b, 24c, and 24d according to reading of the manufacture data. The graphs 24a to 24d respectively include graph areas 25a, 25b, 25c, and 25d, and respectively include item columns 26a, 26b, 26c, and 26d. Note that the manufacture data that is, for example, brought together by manufacture product number and sorted by date and time is used.

In the graph 24a, the manufacture data is before reading, and nothing is displayed on the graph area 25a and the item column 26a. In the graph 24b, the manufacture data has been read to the point in which a manufacture product has finished two manufacturing processes and starts the third manufacturing process. In the graph 24b, time axes for three manufacturing processes and a trace graph associated with the manufacture product is displayed on the graph area 25b. In the graph 24b, items associated with each manufacturing process are displayed in the item column 26b.

The graph 24c is obtained by reading additional manufacture data to the graph 24b. In the graph 24c, the number of manufacturing processes increases to eight, and a trace graph associated with a plurality of manufacture products is displayed on the graph area 25c. In the graph 24c, items associated with the increased manufacturing processes are also displayed in the item column 26c. More specifically, in the graph 24c, time axes associated with the increased manufacturing processes are added. Furthermore, in the graph 24c, an administrator can change the order of the manufacturing processes by dragging and dropping each item in the item column 26c in a manner of an item 27. Note that, in the trace graph, for example, a part along a time axis such as a line segment 28 represents operation in the manufacturing process, and a part between manufacturing processes such as a line segment 29 represents a shift of a manufacture product.

The graph 24d is obtained by changing the order of the item 27 in the graph 24c. In the graph 24d, the most rightward manufacturing process in the graph 24c is shifted to fifth place from the left. As illustrated in an example of FIG. 5, the information processor 100 can display a time line graph based on manufacture data even without a process master.

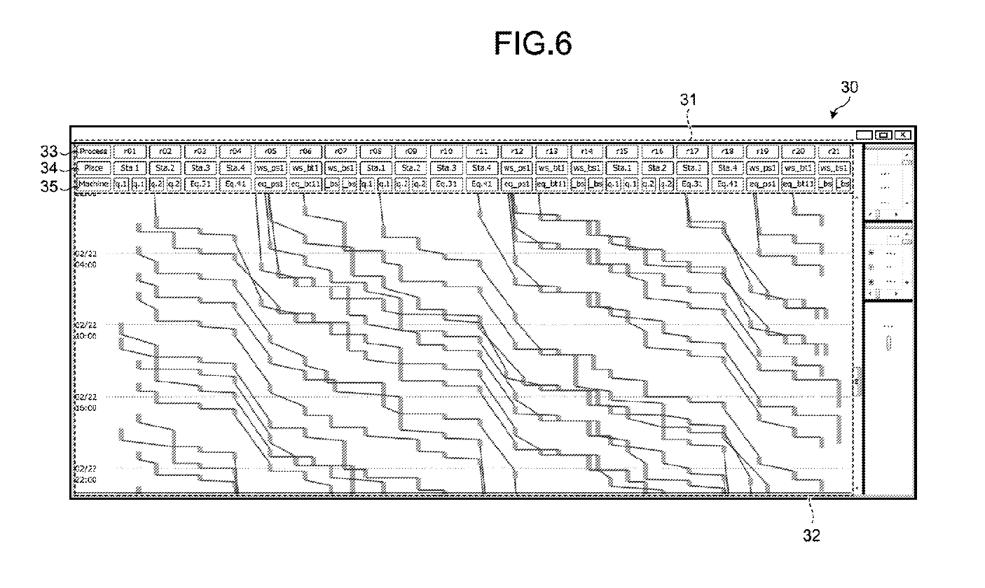

With reference to FIGS. 6 to 11, an example of graphs associated with an arrangement of each level corresponding to each piece of the hierarchized information will now be described. FIG. 6 illustrates one example of graphs. A graph 30 illustrated in FIG. 6 includes an item column 31 and a graph area 32. In the graph 30, each piece of the information in the item column 31 is hierarchized in the order of Process 33, Place 34, and Machine 35 from the top. That is, in the graph 30, a manufacturing process, a place, and equipment have higher priorities in this order. In the graph 30, the manufacturing process has higher priority, and thus the graph indicates flows of manufacture products. Note that, the graph 30 indicates that manufacture products are delayed between manufacturing processes r04 and r05, between manufacturing processes r11 and r12, and between manufacturing processes r18 and r19, but identifying the causes of the delays is difficult.

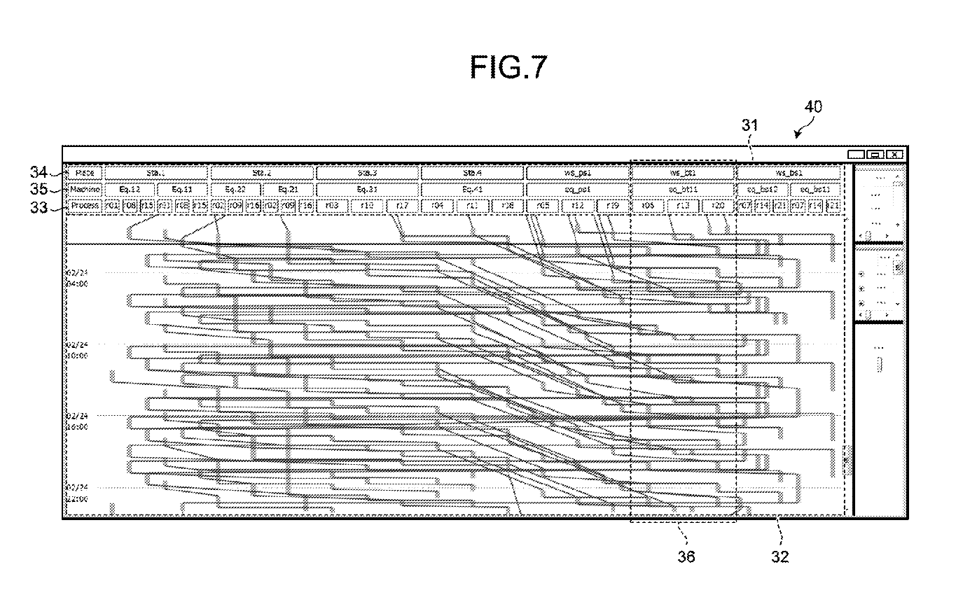

FIG. 7 illustrates another example of graphs, in a graph 40 illustrated in FIG. 7, each piece of the information in the item column 31 is hierarchized in the order of Place 34, Machine 35, and Process 33 from the top. That is, in the graph 40, a place, equipment, and a manufacturing process have higher priorities in this order. In the graph 40, the place has higher priority, and thus the graph indicates operational conditions of the equipment by place. As indicated in an area 36, the graph 40 indicates that there is room in an operational condition of equipment, “eq_bt11” in a place “ws_bt1”. The graph 40 also indicates whether places in manufacturing processes that are close to each other in a flow of a manufacturing line are locationally close or not.

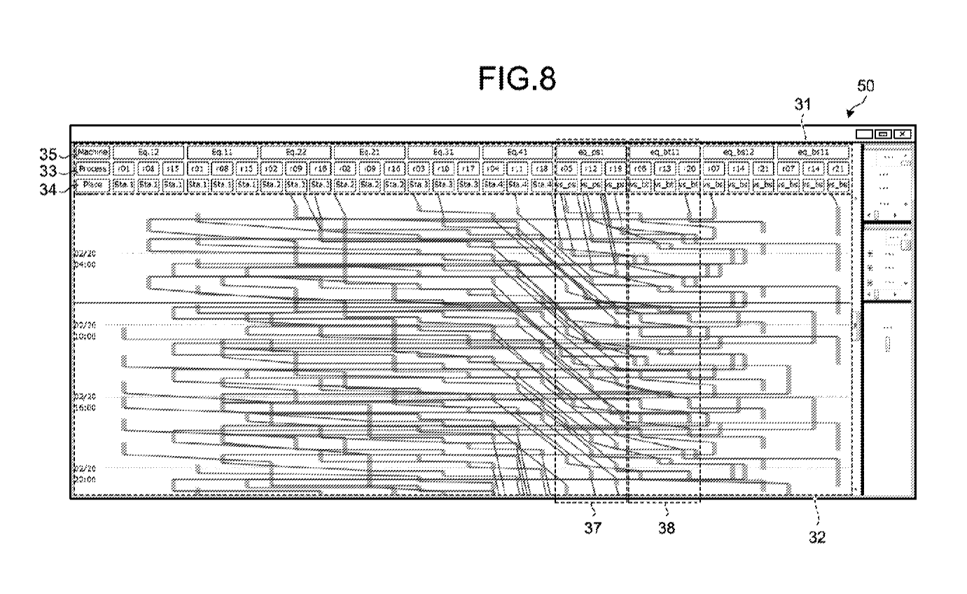

FIG. 8 illustrates another example of graphs. In a graph 50 illustrated in FIG. 8, each piece of the information in the item column 31 is hierarchized in the order of Machine 35, Process 33 and Place 34 from the top. That is, in the graph 50, equipment, a manufacturing process, and a place have higher priorities in this order. In the graph 50, the equipment has higher priority, and thus the graph indicates operational conditions of the equipment. The graph 50 indicates that there is no room in an operational condition of equipment “eq_ps1” in an area 37, which is a bottleneck. The graph 50 also indicates that there is room in an operational condition of equipment “eq_bt11” in an area 38.

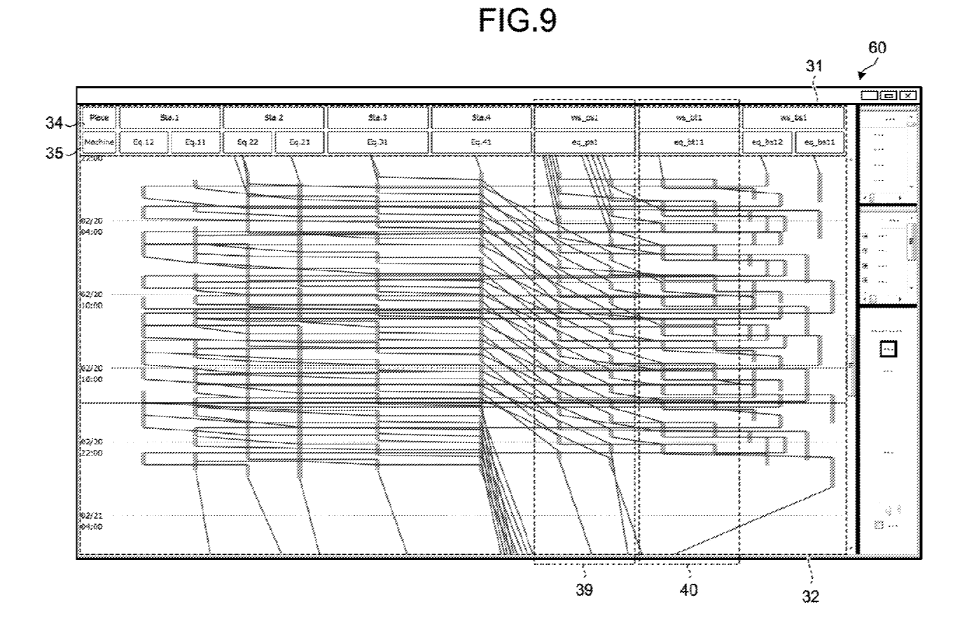

FIG. 9 illustrates another example of graphs. In a graph 60 illustrated in FIG. 9, each piece of the information in the item column 31 is hierarchized in the order of Place 34 and Machine 35 from the top. That is, in the graph 60, a place and equipment have higher priorities in this order. In addition, the manufacturing process is deleted from the item column 31 in the graph 60. This makes the graph easier to see when it is desired to pay attention a place and equipment. In the graph 60, the place has higher priority, and thus the graph indicates operational conditions of the equipment by place. The graph 60 indicates that there is no room in an operational condition of equipment “eq_ps1” in a place “ws_ps1” in an area 33, which is a bottleneck. The graph 60 also indicates that there is room in an operational condition of equipment “eq_bt11” in a place “ws_bt1” in an area 40.

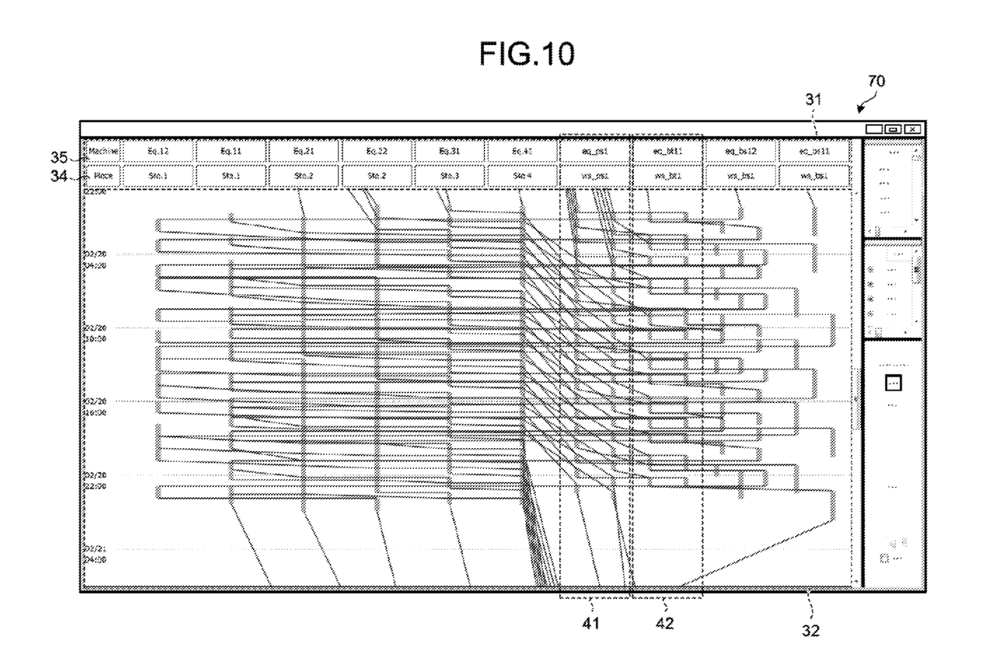

FIG. 10 illustrates another example of graphs. In a graph 70 illustrated in FIG. 10, each piece of the information in the item column 31 is hierarchized in the order of Machine 35 and Place 34 from the top. That is, in the graph 70, equipment and a place have higher priorities in this order. In addition, the manufacturing process is deleted from the item column 31 in the graph 70. This makes the graph easier to see when it is desired to pay attention the equipment and the place. In the graph 70, the equipment has higher priority, and thus the graph indicates operational conditions of the equipment. The graph 70 indicates that there is no room in an operational condition of equipment “eq_ps1” in a place “w_ps1” in an area 41, which is a bottleneck. The graph 70 also indicates that there is room in an operational condition of equipment “eq_bt11” in a place “ws_bt1” in an area 42.

The graph 70 also enables the grasping of, for example, conditions of equipment that addresses the same manufacturing process but that is placed at different positions. When equipment is enhanced, further equipment is generally placed at a nearby site. In a factory undergoing repeated equipment enhancement, however, operations may be continued at a place where equipment is temporarily placed at a busy time. In such a case, equipment may be placed in another building, and shifting a manufacture product may take time. This may reduce frequency in use of the equipment, but periodical maintenance is performed similarly to other equipment. Consequently, operational conditions of equipment are evaluated together with flows of manufacture products rather than evaluated singly. A change of installation place of equipment can be reconsidered, as needed. More specifically, for example, when equipment to be added is placed in a building different from factory building due to shortage of space in spite that the equipment addresses the same manufacturing process, the graph 70 enables easy grasping of operational conditions of the added equipment. This enables an administrator to determine, for example, to lengthen a maintenance interval of the added equipment.

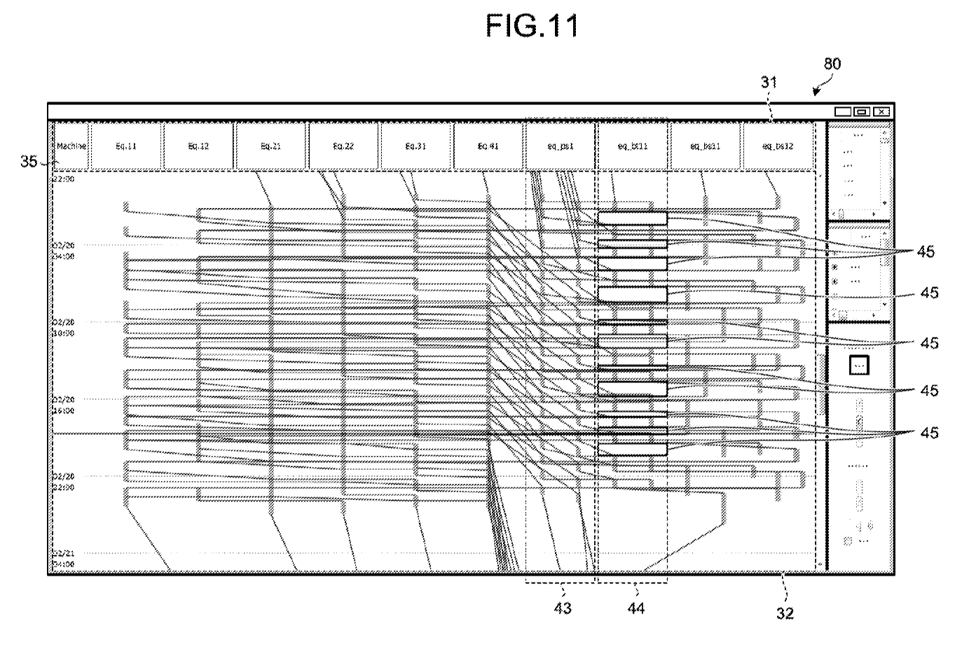

FIG. 11 illustrates the other example of graphs. In a graph 80 illustrated in FIG. 11, the hierarchy of the information in the item column 31 has Machine 35 only. That is, the graph 80 focuses on equipment. More specifically, the manufacturing process and the place are deleted from the item column 31 in the graph 80. This makes the graph easier to see when the equipment is a subject of interest. The graph 80 indicates that there is no room in an operational condition of equipment “eq_ps1” in an area 43, which is a bottleneck. The graph 80 also indicates that there is spare time 45 in an operational condition of equipment “eq_bt11” in an area 44. That is, the graph 80 enables easy evaluation of operation rate of equipment by focusing on the spare time 45.

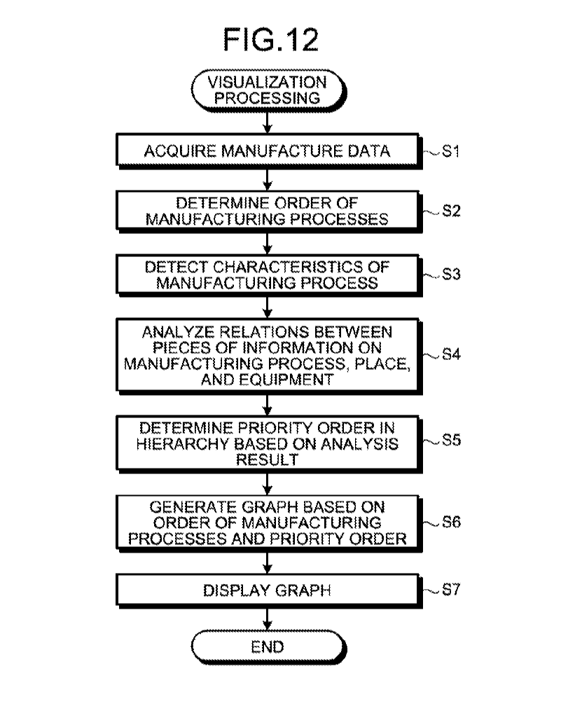

Operation of manufacturing-process visualizing system 1 in an embodiment will now be described. FIG. 12 is a flowchart illustrating one example of visualization processing in the embodiment.

The acquisition unit 131 in the information processor 100 receives and acquires manufacture data from various devices (not illustrated) (Step S1). The acquisition unit 131 stores the acquired manufacture data in the manufacture data storage unit 121.

The determination unit 132 reads manufacture data from the manufacture data storage unit 121 when the determination unit 132, for example, receives an instruction to display a graph from an administrator. The determination unit 132 determines all manufacturing processes which a specific manufacture product has undergone, based on the read manufacture data. Note that a plurality of specific manufacture products is provided. The determination unit 132 also determines the order of each manufacturing process based on time information associated with each manufacturing process involved in all the determined manufacturing processes (Step S2). The determination unit 132 outputs the order of each of the determined manufacturing processes to the generation unit 134. The determination unit 132 also outputs a characteristic detection instruction to the detection unit 133.

The detection unit 133 reads manufacture data from the manufacture data storage unit 121 when a characteristic detection instruction is input from the determination unit 132. The detection unit 133 detects characteristics of each manufacturing process based on the read manufacture data (Step S3). The detection unit 133 outputs process evaluation information on each of the detected manufacturing processes to the generation unit 134.

When the order of each manufacturing process is input from the determination unit 132, the generation unit 134 refers to the manufacture data storage unit 121, and analyzes a relation between pieces of information on a manufacturing process, a place, and equipment, which are to be arranged (Step S4). Based on the analysis result, the generation unit 134 determines a priority order in a hierarchy of each piece of the information to be arranged in a graph (Step S5). The generation unit 134 hierarchizes each piece of the information based on the determined priority order. The generation unit 134 determines an arrangement of item columns in the graph, which correspond to each piece of the hierarchized information, and arranges the item columns.

In addition, when process evaluation information is input from the detection unit 133, the generation unit 134 places the input process evaluation information in a graph in association with identification information for each manufacturing process or symbol information for each manufacturing process.

The generation unit 134 generates the trace graph by associating, along a predetermined time axis direction, a time when each manufacture product undergoes each manufacturing process with the arranged item column. That is, the generation unit 134 generates a graph based on the order of the manufacturing processes and the priority order (Step S6).

The generation unit 134 displays the generated graph on the display unit 111 (Step S7). The generation unit 134 also stores the arrangement of the item columns used in the displayed graph as a process master in the process master storage unit 122. This enables the information processor 100 to easily graph manufacture data, in other words, result data.

In this way, the information processor 100 acquires manufacture data including identification information for a manufacture product, identification information for a manufacturing process which the manufacture product has undergone, and time information indicating a time captured at the time when the manufacture product has undergone the manufacturing process. Furthermore, the information processor 100 determines all manufacturing processes which a specific manufacture product has undergone, based on the acquired manufacture data, and determines the order of each manufacturing process based on time information associated with each manufacturing process involved in all the determined manufacturing processes. The information processor 100 also arranges, in the determined order, identification information for each manufacturing process or symbol information on each manufacturing process. The information processor 100 also generates a graph in which the time when the specific manufacture product undergoes each manufacturing process is, along a predetermined time axis direction, associated with the identification information for each manufacturing process or the symbol information on each manufacturing process, which has been arranged. As a result, result data can be easily graphed.

In addition, the information processor 100 acquires manufacture data on a plurality of manufacture products. The information processor 100 also determines all manufacturing processes which at least one of a plurality of manufacture products has undergone, based on the acquired manufacture data. For any manufacture product, the information processor 100 also determines the order of each manufacturing process based on time information associated with each manufacturing process involved in all the determined manufacturing processes. As a result, result data can be easily graphed even when a plurality of manufacture products is provided.

For identification information on each manufacturing process or symbol information on each manufacturing process, which are arranged in the determined order, the information processor 100 also generates a graph in which the arranged order can be rearranged. This enables a fine adjustment of a graph by an administrator.

The information processor 100 also generates a graph in which information on one or more of a place and equipment associated with each manufacturing process is arranged in association with identification information on each manufacturing process or symbol information on each manufacturing process. As a result, result data can be graphed based on a manufacturing process, equipment, and a place, which are to be focused on.

The information processor 100 also hierarchizes identification information or symbol information, which is to be arranged, and information on one or more of a place and equipment associated with each manufacturing process based on a predetermined priority order, and generates a graph in which the hierarchized levels can be rearranged. As a result, result data can be graphed based on a manufacturing process, equipment, and a place, which are to be focused on.

The information processor 100 analyzes a relation between pieces of the associated information, determines a predetermined priority order, and generates a graph. This enables generation of a graph hierarchized in the more appropriate order.

The information processor 100 also detects characteristics of a manufacturing process based on manufacture data. The information processor 100 also generates a graph in which the detected characteristics are associated with identification information for each manufacturing process or symbol information for each manufacturing process in the graph. This enables generation of a graph by which the characteristics of the manufacturing process can be found at a glance.

Note that, in the above embodiment, a graph is generated by use of manufacture data stored in the manufacture data storage unit 121, but this is not limitative. For example, a graph may be generated based on manufacture data received anytime from various devices (not illustrated), and the graph may be updated every time a new manufacture data is received. This enables manufacture data to be graphed in real time.

In addition, each component of each illustrated part does not necessarily need to be physically configured as illustrated. More specifically, specific forms of distribution/integration in each part are not limited to those as illustrated. All or part of each part can be configured by functional or physical distribution/integration in any unit based on, for example, various loads or usage conditions. For example, the determination unit 132 and the detection unit 133 may be integrated. In addition, each piece of illustrated processing is not limited to the above order, and may be performed simultaneously or in a rearranged order within a range consistent with the processing contents.

Furthermore, all or any part of various processing functions of each device may be implemented by a CPU (or microcomputer such as an MPU and a micro controller unit (MCU)). It is needless to say that all or any part of various processing functions may also be implemented by a program analyzed and executed by a CPU (or microcomputer such as an MPU and an MCU), or by hardware through the use of wired logic.

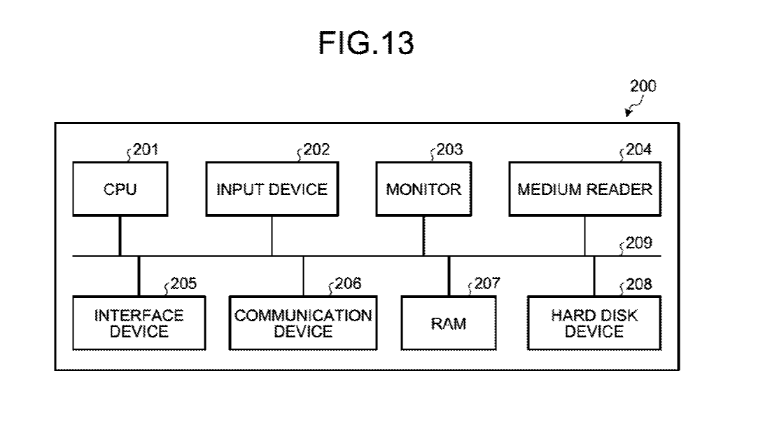

Incidentally, various pieces of processing illustrated in the above embodiment can be performed by executing preliminarily prepared programs with a computer. One example of computers that execute a program with a function similar to that in the above embodiment will then be described below. FIG. 13 illustrates one example of computers that execute a manufacturing-process visualizing program.

As illustrated in FIG. 13, a computer 200 includes a CPU 201, an input device 202 and a monitor 203. The CPU 201 executes various kinds of arithmetic processing. The input device 202 receives data input. The computer 200 also includes a medium reader 204, an interface device 205, and a communication device 206. The medium reader 204 reads, for example, a program from a storage medium. The interface device 205 is for connection with various devices. The communication device 206 is for connection with another device such as an information processor by wire or wirelessly. The computer 200 also includes a RAM 207 and a hard disk device 208. The RAM 207 temporarily stores various pieces of information. Furthermore, each of the devices 201 to 208 is connected with a bus 209.

A manufacturing-process visualizing program is stored in the hard disk device 208. The program has functions similar to those of each processing unit of the acquisition unit 131, the determination unit 132, the detection unit 133, and the generation unit 134, which are illustrated in FIG. 1. The manufacture data storage unit 121, the process master storage unit 122, and various kinds of data for executing the manufacturing-process visualizing program are also stored in the hard disk device 208. For example, the input device 202 receives inputs of various pieces of information such as operation information and administration information from an administrator of the computer 200. For example, the monitor 203 displays various images such as display screens for an administrator of the computer 200. For example, a printer is connected with the interface device 205. For example, the communication device 206 has a function similar to that of the communication unit 110 illustrated in FIG. 1, is connected with a network (not illustrated), and communicates various pieces of information with various devices (not illustrated).

The CPU 201 performs various kinds of processing by reading each program stored in the hard disk device 208, and decompressing and executing the program on the RAM 207. These programs also enable the computer 200 to function as the acquisition unit 131, the determination unit 132, the detection unit 133, and the generation unit 134, which are illustrated in FIG. 1.

Note that the above manufacturing-process visualizing program does not necessarily need to be stored in the hard disk device 208. For example, the computer 200 may read and execute a program stored in a storage medium that the computer 200 can read. Examples of storage media that the computer 200 can read include portable recording media such as a compact disc read-only memory (CD-ROM), a digital versatile disc (DVD), and a Universal Serial Bus (USB) memory, a semiconductor memory such as a flash memory, and a hard disk drive. In addition, the manufacturing-process visualizing program may be stored in devices connected to, for example, a public line, the Internet, and a LAN, and the computer 200 may read and execute the manufacturing-process visualizing program from those devices.

According to an aspect of the disclosed embodiment, result data can be easily graphed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a manufacturing-process visualizing program that causes a computer to execute a process for visualizing a manufacturing process in a manufacturing line based on manufacture data acquired in processing of manufacturing a manufacture product in the manufacturing line, the process comprising:
acquiring manufacture data including identification information for a manufacture product, identification information for a manufacturing process which the manufacture product has undergone, and time information indicating a time captured at a time when the manufacture product has undergone the manufacturing process;
determining all manufacturing processes which a specific manufacture product has undergone, based on the acquired manufacture data, and determining an order of each of manufacturing processes based on time information associated with each of the manufacturing processes involved in all the determined manufacturing processes; and
arranging, in the determined order, identification information for each of the manufacturing processes or symbol information on each of the manufacturing processes, and generating a graph in which a time when the specific manufacture product undergoes each of the manufacturing processes is, along a predetermined time axis direction, associated with the identification information for each of the manufacturing processes or the symbol information on each of the manufacturing processes, which has been arranged.

2. The non-transitory computer-readable recording medium according to claim 1, wherein
the acquiring includes acquiring the manufacture data on a plurality of the manufacture products, and
the determining includes determining all manufacturing processes which at least one of the plurality of manufacture products has undergone based on the acquired manufacture data, and determining, for one of the manufacture products, an order of each of manufacturing processes based on time information associated with each of the manufacturing processes involved in all the determined manufacturing processes.

3. The non-transitory computer-readable recording medium according to claim 1, wherein
the generating includes generating, for identification information on each of the manufacturing processes or symbol information on each of the manufacturing processes which are arranged in the order, the graph in which the arranged order is enabled to be rearranged.

4. The non-transitory computer-readable, recording medium according to claim 1, wherein
the generating includes generating the graph in which information on one or more of a place and equipment associated with each of the manufacturing processes is arranged in association with identification information on each of the manufacturing processes or symbol information on each of the manufacturing processes.

5. The non-transitory computer-readable recording medium according to claim 4, wherein
the generating includes hierarchizing the identification information or the symbol information which are to be arranged, and information on one or more of a place and equipment associated with each of the manufacturing processes based on a predetermined priority order, and generating the graph in which each of the hierarchized levels is enabled to be rearranged.

6. The non-transitory computer-readable recording medium according to claim 5, wherein
the generating includes analyzing a relation between pieces of the associated information, determining the predetermined priority order, and generating the graph.

7. The non-transitory computer-readable recording medium according to claim 1, wherein the process further comprises
detecting a characteristic of the manufacturing process based on the manufacture data, wherein
the generating includes generating the graph in which the detected characteristic is associated with identification information for each of the manufacturing processes or symbol information for each of the manufacturing processes in the graph.

8. A manufacturing-process visualizing method for visualizing a manufacturing process in a manufacturing line based on manufacture data acquired in processing of manufacturing a manufacture product in the manufacturing line, the manufacturing-process visualizing method comprising:
acquiring manufacture data including identification information for a manufacture product, identification information for a manufacturing process which the manufacture product has undergone, and time information indicating a time captured at a time when the manufacture product has undergone the manufacturing process, using a processor;
determining all manufacturing processes which a specific manufacture product has undergone, based on the acquired manufacture data, and determining an order of each of manufacturing processes based on time information associated with each of the manufacturing processes involved in all the determined manufacturing processes, using the processor; and
arranging, in the determined order, identification information for each of the manufacturing processes or symbol information on each of the manufacturing processes, and generating a graph in which a time when the specific manufacture product undergoes each of the manufacturing processes is, along a predetermined time axis direction, associated with the identification information for each of the manufacturing processes or the symbol information on each of the manufacturing processes, which has been arranged, using the processor.

9. The manufacturing-process visualizing method according to claim 8, wherein
the acquiring includes acquiring the manufacture data on a plurality of the manufacture products, and
the determining includes determining all manufacturing processes which at least one of the plurality of manufacture products has undergone based on the acquired manufacture data, and determining, for one of the manufacture products, an order of each of manufacturing processes based on time information associated with each of the manufacturing processes involved in all the determined manufacturing processes.

10. The manufacturing-process visualizing method according to claim 8, wherein
the generating includes generating, for identification information on each of the manufacturing processes or symbol information on each of the manufacturing processes which has been arranged in the order, the graph in which the arranged order is enabled to be rearranged.

11. The manufacturing-process visualizing method according to claim 8, wherein
the generating includes generating the graph in which information on one or more of a place and equipment associated with each of the manufacturing processes is arranged in association with identification information on each of the manufacturing processes or symbol information on each of the manufacturing processes.

12. The manufacturing-process visualizing method according to claim 11, wherein
the generating includes hierarchizing the identification information or the symbol information which are to be arranged, and information on one or more of a place and equipment associated with each of the manufacturing processes based on a predetermined priority order, and generating the graph in which each of the hierarchized levels is enabled to be rearranged.

13. The manufacturing-process visualizing method according to claim 12, wherein
the generating includes analyzing a relation between pieces of the associated information, determining the predetermined priority order, and generating the graph.

14. The manufacturing-process visualizing method according to claim 8, further comprising
detecting a characteristic of the manufacturing process based on the manufacture data, using the processor, wherein
the generating includes generating the graph in which the detected characteristic is associated with identification information for each of the manufacturing processes or symbol information for each of the manufacturing processes in the graph.

15. A manufacturing-process visualizing system for visualizing a manufacturing process in a manufacturing line based on manufacture data acquired in processing of manufacturing a manufacture product in the manufacturing line, the manufacturing-process visualizing system comprising:
a memory; and
a processor coupled to the memory, wherein the processor executes a process comprising:
acquiring manufacture data including identification information for a manufacture product, identification information for a manufacturing process which the manufacture product has undergone, and time information indicating a time captured at a time when the manufacture product has undergone the manufacturing process;
determining all manufacturing processes which a specific manufacture product has undergone, based on the acquired manufacture data, and determining an order of each of manufacturing processes based on time information associated with each of the manufacturing processes involved in all the determined manufacturing processes; and
arranging, in the determined order, identification information for each of the manufacturing processes or symbol information on each of the manufacturing processes, and generating a graph in which a time when the specific manufacture product undergoes each of the manufacturing processes is, along a predetermined time axis direction, associated with the identification information for each of the manufacturing processes or the symbol information on each of the manufacturing processes, which has been arranged.

16. The manufacturing-process visualizing system according to claim 15, wherein
the acquiring includes acquiring the manufacture data on a plurality of the manufacture products, and
the determining includes determining all manufacturing processes which at least one of the plurality of manufacture products has undergone based on the acquired manufacture data, and determining, for one of the manufacture products, an order of each of manufacturing processes based on time information associated with each of the manufacturing processes involved in all the determined manufacturing processes.

17. The manufacturing-process visualizing system according to claim 15, wherein
the generating includes generating, for identification information on each of the manufacturing processes or symbol information on each of the manufacturing processes which are arranged in the order, the graph in which the arranged order is enabled to be rearranged.

18. The manufacturing-process visualizing system according to claim 15, wherein
the generating includes generating the graph in which information on one or more of a place and equipment associated with each of the manufacturing processes is arranged in association with identification information on each of the manufacturing processes or symbol information on each of the manufacturing processes.

19. The manufacturing-process visualizing system according to claim 18, wherein
the generating includes hierarchizing the identification information or the symbol information which are to be arranged, and information on one or more of a place and equipment associated with each of the manufacturing processes based on a predetermined priority order, and generating the graph in which each of the hierarchized levels is enabled to be rearranged.

20. The manufacturing-process visualizing system according to claim 19, wherein
the generating includes analyzing a relation between pieces of the associated information, determining the predetermined priority order, and generating the graph.
